(19) United States
(12) Patent Application Publication
(10) Pub. No.: US 2022/0391216 A1
(43) Pub. Date: Dec. 8, 2022

(54) GRAPHICS PROCESSING

(71) Applicant: Arm Limited, Cambridge (GB)

(72) Inventors: Richard Edward BRUCE, Cambridge (GB); William Robert STOYE, Cambridge (GB)

(21) Appl. No.: 17/804,453

(22) Filed: May 27, 2022

(30) Foreign Application Priority Data
Jun. 4, 2021 (GB) 2108052.8

(51) Int. Cl. G06F 9/38; G06T 1/20

(52) U.S. Cl. CPC G06F 9/3869; G06F 9/3885; G06T 1/20

(57) ABSTRACT

There is disclosed an instruction that can be included into a graphics processor shader program to be executed by a group of execution threads that when executed will cause a group of execution lanes to be in an ‘active’ (e.g. SIMD) execution state in which active state processing operations can be performed using the group of plural execution lanes together. The processing operations can then be performed using the execution lanes in the active state together. The execution lanes are then allowed or caused to return to their prior execution state once the processing operations have finished.

### CROSS-REFERENCE TO RELATED APPLICATIONS

This application claims priority pursuant to 35 U.S.C. 119(a) to United Kingdom Patent Application No. 2108052.8, filed Jun. 4, 2021, which application is incorporated herein by reference in its entirety.

### BACKGROUND

The technology described herein relates to graphics processing systems, and in particular to graphics processors that include one or more programmable processing stages (“shaders”).

Many graphics processing pipelines now include one or more programmable processing stages, commonly referred to as “shaders”. For example, a graphics processing pipeline may include one or more of, and typically all of: a geometry shader, a vertex shader, and a fragment (pixel) shader. These shaders are programmable processing stages that execute shader programs on input data values to generate a desired set of output data, for example appropriately shaded and rendered fragment data in the case of a fragment shader, for processing by the rest of the graphics pipeline and/or for output.

The shaders of the graphics processing pipeline may share programmable processing circuit(s), or they may each be executed by distinct programmable processing units.

A graphics processing unit (GPU) shader core is thus a processing unit that performs graphics processing by running small programs for each graphics “work” item in a graphics output, such as a render target, e.g. frame, to be generated (an “item” in this regard is usually a vertex or a sampling position (e.g. in the case of a fragment shader)). This generally enables a high degree of parallelism, in that a typical render output, e.g. frame, features a rather large number of vertices and fragments, each of which can be processed independently.

In graphics shader operation, each work “item” will normally be processed by means of an execution thread which will execute the instructions of the shader program in question for the graphics work “item” in question.

Shader program execution efficiency may be improved by grouping execution threads (where each thread corresponds, e.g., to one vertex in the case of a vertex shader, but could also correspond, e.g., to a ray for use in a ray tracing operation, a sampling position that is being rendered, etc., depending on the nature of the shader program) into “groups” or “bundles” of threads, where the threads of one group are run in lockstep, e.g. one instruction at a time (single instruction, multiple threads (SIMT) execution). In this way, it is possible to share (e.g.) instruction fetch and scheduling resources between all the threads in the group. Other terms used for such thread groups include “warps” and “wave fronts”. For convenience, the term “thread group” will be used herein, but this is intended to encompass all equivalent terms and arrangements, unless otherwise indicated.

In a system where execution threads can be grouped into thread groups, then the functional units for performing the processing operations in response to the instructions in a shader program are normally correspondingly operable so as to facilitate such thread group arrangements. Typically, the functional units are each arranged with plural respective execution lanes, so that a functional unit can execute the same instruction in parallel for plural threads of a thread group.

It is also possible to use multiple processing elements (e.g. a group of plural execution threads executing across plural execution lanes) to perform the same operation on multiple data points simultaneously (single instruction, multiple data (SIMD) execution). In that case an instruction can be defined in terms of its execution as a single thread, such that the group of execution threads executing in SIMD state can be thought of as a single programmable element (rather than a plurality of separate threads executing in lockstep). In the SIMD state, all of the execution lanes may therefore be active, and executing the same instruction.

Again, this can provide various efficiencies in terms of sharing the processing load between multiple processing elements, e.g., between plural execution lanes, in particular when the same operation needs to be performed multiple times for different data points.

The Applicants believe that there remains scope for improvements to graphics processors including such programmable execution units.

### DESCRIPTION OF THE DRAWINGS

FIG. 1 shows an exemplary graphics processing system;

FIG. 2 shows schematically the compiling of a shader program for execution by a graphics processing pipeline;

FIG. 3 shows schematically the arrangement of execution lanes according to an embodiment of the technology described herein;

FIG. 4 shows schematically the arrangement of an execution lane pipeline according to an embodiment of the technology described herein;

FIG. 5 shows schematically the arrangement of execution lane pipelines in embodiments of the technology described herein;

FIG. 6 illustrates a control of the processing state of different execution lanes according to an embodiment of the technology described herein;

FIG. 7 is a flow chart showing a high level operation according to an embodiment of the technology described herein;

FIG. 8 shows in more detail the operation according to an embodiment of the technology described herein; and

FIG. 9 is a flow chart showing the compilation operation according to an embodiment of the technology described herein.

### DESCRIPTION

A first embodiment of the technology described herein comprises a method of operating a graphics processing system including a graphics processor,

the graphics processor comprising a programmable execution unit operable to execute programs to perform graphics processing operations, wherein the execution unit is configured as a plurality of execution lanes, wherein individual execution threads in a group of plural execution threads can be executed by respective execution lanes, the method comprising:

including in a program to be executed by a group of plural execution threads, an activation instruction that when executed by an execution thread in the group of execution threads will cause a group of plural execution lanes to be in an ‘active’ state in which processing operations can be performed using the plural execution lanes together; and including in the program, subsequent to the activation instruction that will cause the group of plural execution lanes to be in the ‘active’ state, a set of one or more instructions to cause one or more processing operations to be performed using the group of plural execution lanes together; the method further comprising:

when the program is being executed by an execution thread, in response to the execution thread executing the activation instruction:

causing a group of plural execution lanes to be in an ‘active’ state in which active state processing operations can be performed using the group of plural execution lanes together; and then performing one or more processing operations using the group of plural execution lanes together.

A second embodiment of the technology described herein comprises a graphics processing system comprising:

a graphics processor comprising a programmable execution unit operable to execute programs to perform graphics processing operations, wherein the execution unit is configured as a plurality of execution lanes, wherein individual execution threads in a group of plural execution threads can be executed by respective execution lanes, and

a processing circuit that is configured to:

include in a program to be executed by a group of plural execution threads, an activation instruction that when executed by an execution thread in the group of execution threads will cause a group of plural execution lanes to be in an ‘active’ state in which processing operations can be performed using the plural execution lanes together; and

include in the program, subsequent to the activation instruction that will cause the group of plural execution lanes to be in the ‘active’ state, a set of one or more instructions to cause one or more processing operations to be performed using the group of plural execution lanes together;

wherein the graphics processor is configured such that, when the program is being executed by an execution thread, in response to the execution thread executing the activation instruction:

a group of plural execution lanes is caused to be in an ‘active’ state in which active state a subsequent set of one or more processing operations can be performed using the group of plural execution lanes together.

The technology described herein broadly relates to graphics processing systems which include a graphics processor comprising a programmable execution unit that is operable to execute programs to perform graphics processing operations, and in which a program can be executed by groups of plural execution threads together. To facilitate this, the execution unit in the technology described herein is configured as a plurality of execution lanes, wherein individual execution threads of thread groups that are being executed to execute instructions for the program can be issued to respective execution lanes for execution. The execution unit can thus execute a group of threads in parallel, with individual threads in the group being executed by respective execution lanes.

More specifically, the technology described herein relates to controlling the processing state of the different execution lanes of the execution unit.

In particular, the technology described herein provides an instruction that when executed will cause a whole group of plural execution lanes to be in an ‘active’ state, e.g. such that the group of plural execution lanes can execute a corresponding group of execution threads (e.g. a whole ‘warp’) together.

When a group of plural execution lanes is in the ‘active’ state, the group of plural execution lanes can thus be treated, and used, as a whole, e.g. as a single processing element, e.g., and in an embodiment, in a single instruction, multiple data (SIMD) execution state in which all of the execution lanes simultaneously execute execution threads that perform the same set of processing operations, but for different data points, e.g. with individual execution lanes executing execution threads associated with respective data points. In the ‘active’ state, the execution lanes in the group of execution lanes will thus in an embodiment all execute threads to perform the same set of processing operations.

Thus, in some embodiments described herein, the ‘activation’ instruction will for ease of explanation also be referred to as an ‘enter_SIMD_state’ instruction.

In embodiments, the activation (enter_SIMD_state) instruction when executed will cause all of the execution lanes of the execution unit to be in the ‘active’ state together, e.g. such that a subsequent sequence of processing operations can be performed using all of the execution lanes together.

Accordingly, various embodiments will be described herein wherein the activation (enter_SIMD_state) instruction when executed causes all of the execution lanes of the execution unit to be in the active state, e.g., and in an embodiment, so that the execution lanes can execute a whole group of execution threads (e.g. a whole ‘warp’) in common, e.g. to perform the same processing operations. However, it would also be possible for the activation (enter_SIMD_state) instruction to cause less than all of the execution lanes to be in the ‘active’ state. This may be appropriate, for example, when the number of execution lanes is larger than the number of execution threads in a single execution thread group (warp) that is to be used to perform processing operations together.

Thus, in general, the activation instruction when executed may cause at least a subset of the execution lanes of the execution unit (including the execution lane executing the thread that executed the activation instruction) to be in the active state.

Any references to a group of execution lanes being in an ‘active’ state should therefore be understood accordingly to mean either that all of the execution lanes, or a suitable subset of the execution lanes, are in the active state.

The activation (enter_SIMD_state) instruction can thus be included in a shader program to be executed at a suitable position ahead of a set of processing operations that is to be performed using a group of execution lanes as a whole (e.g., and in an embodiment, in SIMD execution state). In this way, once an execution thread (or threads) in a thread group that is executing the program executes the activation (enter_SIMD_state) instruction, such that a group of plural (e.g. all of the) execution lanes of the execution unit are caused to be in the ‘active’ state, a subsequent set of one or more processing operations can then be performed using the group of plural execution lanes in the active state together.

After the activation (enter_SIMD_state) instruction has been executed, an execution thread group being executed by the group of plural execution lanes in the active state can thus start executing an arbitrary set of one or more processing operations that are to be executed using the plural execution threads together, as desired, as it can be (and is) ensured at this point that all of the execution lanes in the group of plural execution lanes will be in the active state.

Once the set of processing operations that are to be performed using the group of plural execution lanes together (e.g. in SIMD execution state) have finished, the execution threads being executed by the execution lanes are in an embodiment then allowed (or caused) to return to their previous execution state, as desired, e.g. as will be explained further below.

Thus, in embodiments, the method further comprises allowing (or causing) the execution lanes to return to their prior execution state, i.e. the state they were in prior the activation (enter_SIMD_state) instruction being executed.

The use of the activation (enter_SIMD_state) instruction in the technology described herein thus provides an efficient way to ensure that a group of execution lanes are all in the same ‘active’ state together, such that a subsequent set of processing operations can then be performed using the whole group of execution lanes together (e.g. in SIMD execution state).

In this respect, the present inventors have recognised that there may be various situations where it may be desired (or required) for a whole group of plural execution lanes to be in an active state together, such that the same, single set of processing operations can be executed across the whole group of execution lanes (e.g. in SIMD execution state), but wherein less than all of the execution lanes may be active at the point at which the set of processing operations are required to be executed.

For example, there are certain situations where a set of processing operations can be coded more efficiently when it is known that all of the execution lanes will be active and operable to perform the same set of processing operations (e.g. in SIMD execution state). Another example of where this might be beneficial is when performing a set of processing operations in which data is to be loaded across multiple execution lanes of a programmable execution unit of a graphics processor, e.g. into a set of shared register files allocated for a group of execution threads executing across the execution lanes. Various other examples would be possible.

The present inventors further recognise that, at any particular instant, different execution threads of a given thread group being executed by a group of plural execution lanes may have various different execution states.

For instance, at least some execution lanes may already be executing threads of a given thread group to perform the set of processing operations when the set of processing operations fall to be performed, such that those lanes are already actively executing the part of the program that requires the processing operations to be performed. These threads can and should therefore be retained in their current, ‘active’ state for the set of processing operations that are to be performed using the group of plural execution lanes together (e.g. in SIMD execution state). Likewise, any data associated with these threads should be retained since this will be valid for the set of processing operations.

However, there may be other execution lanes that are not active to perform the set of processing operations at the point when the set of processing operations fall to be performed.

The technology described herein thus recognises that there is a need for, and provides a mechanism to allow, any execution lanes that are not currently active for a program that requires one or more processing operations to be performed using a group of plural execution lanes together (e.g. in SIMD execution state) to be brought into the desired common, active state for performing the processing operations.

Moreover, the technology described herein recognises that different actions should be (and in an embodiment are) taken depending on the state of an execution lane at the point at which this operation occurs, e.g. depending on whether an execution lane is executing an execution thread or not.

For instance, there are various reasons why an execution lane may not be active at a particular processing instance.

For example, it may be the case (e.g., and especially, in a fragment shader) that some of the execution threads of a given group of execution threads performing a program have been terminated/retired by this point.

As another example, it may also be the case that an execution thread was not generated for a particular execution lane, e.g. as there was not enough processing work (e.g. from a previous processing stage) to generate the execution thread, or because the data point to which the execution thread relates has been culled as a result of some forward culling operation (e.g. early depth testing in a fragment shader).

In such cases the execution lane may therefore be inactive, as it is not currently executing any execution threads to perform any processing work.

In order to bring the execution lane into the desired active state, a new execution thread should therefore be generated for executing the set of processing operations that are to be executed using the group of lanes together (e.g. in SIMD state) and issued to the execution lane for execution.

Thus, in embodiments, in response to executing the activation instruction: the method comprises: for any execution lanes that are not active at the point at which the activation instruction is executed: generating a new execution thread for executing the set of one or more processing operations.

The newly generated execution thread can then be included into the execution thread group that is to be executed using the group of plural execution lanes appropriately, such that the subsequent set of processing operations can be performed using the execution threads in the active group of plural execution lanes together.

In that case, the newly generated execution thread can be suitably initialised for the subsequent set of processing operations that are to be performed for the execution thread group using the group of plural execution lanes as a whole, as required, e.g., and in an embodiment, by loading a suitable set of default (e.g. zero) values into an associated register file for the execution thread so that the execution thread is then active and available for the set of processing operations as part of the overall execution thread group.

It may also be the case that some execution lanes are executing threads that are currently performing processing work but for a different part of the program, e.g. as a result of a conditional operation (e.g. a divergence) that has caused the execution threads' program execution to diverge. Again, in that case, the execution lanes are not in the desired (same) active state as the execution thread that executes the activation instruction (and thus triggers the operation of the technology described herein), as they are busy with other processing work, e.g. for another part of the program.

In that case, in order to bring the (divergent) execution threads into the desired active state, the execution threads should therefore be moved to the current program (i.e. the program that triggered the activation instruction and that requires the processing operations to be performed).

Thus, in embodiments, in response to executing the activation instruction: the method comprises: for any execution lanes executing an execution thread that has diverged from the program that requires the one or more processing operations to be performed: causing the divergent execution thread to jump to the part of the program that requires the one or more processing operations to be performed.

Since any such divergent threads were executing a different part of the program, any data associated with those threads may (and typically will) not be valid for part of the program requiring the set of processing operations.

Any associated data stored for those lanes therefore should not be used, e.g. as this may cause erroneous (or, at the least, unnecessary) processing. This therefore needs to be handled appropriately. Again, therefore, suitable default (e.g. zero) values are in an embodiment loaded, e.g. to suitably initialise the threads for the processing operations to be performed in the active (e.g. SIMD) state.

Thus, for any execution lanes that were not already executing the program at the point at which the activation (enter_SIMD_state) instruction was executed, and thus need to be brought into the active state, a set of default (e.g. zero) values is in an embodiment loaded for (e.g., and in an embodiment, into the associated register files) for those threads.

(For instance, to give a specific example, in the context of a ray tracing traversal operation which is to be performed by a group of plural execution threads (as this may, e.g., allow the ray tracing operation to be managed more efficiently), and in which each execution thread may represent a particular ray for which the same traversal operation is to be performed, for any execution threads that are active, i.e. contain an active/valid ray, the rays can be caused to perform the traversal operation as desired. However, any threads that were previously inactive may not contain any real or valid rays.

Thus, to avoid any data associated with those threads that might otherwise trigger an undesired traversal operation to be performed, a ray having a zero length may be loaded for those threads, such that the ray tracing traversal finishes immediately for those threads (since a ray with zero length cannot intersect any geometry in the scene that is being rendered).)

For any newly generated threads, the threads will not be associated with any valid data for any processing operation (since they were generated in response to the activation (enter_SIMD_state) instruction).

However, a thread that was executing a different part of the program will be associated with valid data for its respective part of the program. For any divergent threads (e.g. that were executing a different part of the program), any associated data, e.g. in the register files, should thus be, and in an embodiment is, maintained and stored appropriately, e.g. so that the data can be restored. In this way, the execution thread can be restored to its previous processing state, e.g. to continue executing instructions for its respective part of the program, once the set of processing operations being performed together (e.g. in SIMD state) has finished, as will be explained further below.

On the other hand, the execution threads that are already actively executing the program (e.g. including the execution thread that triggers the operation of the technology described herein) can continue executing the program, as desired. For instance, these threads may already be associated with valid data for the processing operations, and so the data should be retained appropriately, e.g. in the associated register files for those execution threads, e.g., such that the subsequent set of processing operations to be performed using the group of lanes (e.g. in SIMD state) can be performed accordingly using that data.

Accordingly, any threads that were already executing the program can be (and in an embodiment are) retained, and used to start executing instructions to perform the subsequent set of processing operations.

Thus, in embodiments, the method comprises: for any execution lanes already executing the part of the program that requires the set of one or more processing operations to be performed: retaining any data associated with the execution thread and causing the execution thread to start performing the one or more processing operations.

In all such cases, regardless of the precise state of the execution threads in the execution lanes at the point at which the activation (enter_SIMD_state) instruction is executed, the technology described herein allows a group of plural execution lanes to be brought into the same ‘active’ state together such that a subsequent set of processing operations can then be performed using the group of plural execution lanes together, and as a whole.

That is, whatever the previous state of the execution lanes, according to the technology described herein, a group of execution lanes are brought into the same ‘active’ state so that they are ready and available to be used for processing data for a subsequent set of processing operations that are to be performed simultaneously using all of the execution lanes in the group (e.g. in SIMD state).

The effect of this is then that all of the execution lanes are available and active for processing data together, without their previous state interfering with the desired processing operations. By maintaining the execution thread group active as a whole across the group of plural execution lanes, this may then, e.g., allow shared resources of the group of execution lanes as a whole (e.g. a shared set of register files) to be utilised for the processing operations, as desired.

As explained above, this is done in the technology described herein by providing an activation (enter_SIMD_state) instruction that can be included into a shader program to be executed by the execution unit and that, when executed by an execution thread, causes a whole group of plural execution lanes to become active. In this way, the execution lanes in the group of execution lanes can be caused to transition from an arbitrary state of thread execution into an ‘active’ state as a group, such that the desired processing operations can then be performed using the group of execution lanes as a whole.

In an embodiment this activation operation is performed in such a manner that the execution lanes can be returned to their previous execution state once the set of processing operations to be performed using the group of execution lanes together has finished. Thus, in embodiments, after the one or more processing operations have been performed using the group of plural execution lanes together, the execution lanes are allowed (and in embodiments are caused) to return to their previous execution state.

In this respect the present inventors further recognise that when such an activation (enter_SIMD_state) instruction is executed, the execution threads being executed by the group of plural execution lanes that are caused to become active may need to be handled differently depending on what state they were in before the instruction was executed, e.g., and in particular, depending on whether the execution lane was active/not active at the point at which the activation (enter_SIMD_state) instruction was executed.

For example, as explained above, in response to the activation (enter_SIMD_state) instruction being executed, any execution lanes that were already active for the program in an embodiment remain active, whereas any execution lanes that were not active are caused to become active.

Any execution threads that already existed at the point at which the activation (enter_SIMD_state) instruction will already be associated with useful processing work and are in an embodiment therefore restored, e.g. to continue their previous program execution. That is, rather than, e.g., discarding any existing threads and generating a new thread group for performing the processing operations, any existing threads are in an embodiment suitably suspended, e.g. such that their program execution can subsequently be resumed, e.g. by returning the threads to their previous execute state.

Any suitable suspend/resume mechanism may be used as desired. In embodiments, to facilitate returning the threads to their previous execution state, the state of the execution lanes at the point at which the activation (enter_SIMD_state) instruction is executed is therefore in an embodiment determined, and an indication of this state is in an embodiment stored and carried through the processing operations to allow the execution lanes to be returned to their previous execution state once the one or more processing operations that are to be performed using the group of plural execution lanes together have finished.

Thus, in embodiments, in response to executing the activation instruction: the method comprises (and the execution unit is configured for): for each execution lane in the group of plural execution lanes that is caused to be in the active state: determining the execution state of the execution lane at the point prior to which the activation instruction was executed; and storing an indication of the prior execution state such that the execution lanes can be returned to their prior execution once the set of one or more processing operations using the group of plural execution lanes together has finished.

Correspondingly, when the set of one or more processing operations using the group of plural execution lanes together has finished, the indication of the prior execution state can then be read and used to return the execution lanes to their previous execution state.

Thus, the prior state of the execution lanes (before they were caused to be in the active state) is in an embodiment tracked as part of the operation according to the technology described herein, e.g. such that once the processing operations to be performed using the group of execution lanes in the active state together have finished, the execution threads can then be, and in an embodiment, are returned to their prior execution state appropriately, e.g. as will be explained further below. In particular, it is in an embodiment tracked whether a lane was active/not active prior to the activation (enter_SIMD_state) instruction being executed. An indication of this is in an embodiment provided for each execution thread.

This indication can take any suitable form as desired but in some embodiments is provided in the form of an ‘active flag’ which may, e.g., be, and in an embodiment is, stored as a suitable one or more bit values in the registers for the execution thread. For example, one or more, and in an embodiment a single, bit value may be used to indicate whether or not the execution thread was active at the time the active (SIMD) state was entered. Another one or more bit value may be used to indicate, e.g., whether the thread was inactive but not yet terminated. However, any suitable indication scheme may be used for this purpose, as desired, to indicate any relevant and suitable information about the previous state of the execution thread that may be used to return the execution threads to their previous state.

Thus, in embodiments, in response to an execution thread executing the activation (enter_SIMD_state) instruction, the graphics processor is thus caused to store an indication of the prior active/inactive state for each of the execution threads for the group of plural execution lanes that are caused to be in the active state. This indication is in an embodiment written to the respective registers for each of the execution threads so that the active/inactive state information can be carried through until the set of processing operations have finished. This information can then be used to allow the execution threads to subsequently return to their previous execution state. Thus, once the set of processing operations being performed using the execution thread group as a whole (in SIMD state) has finished, the threads are in an embodiment allowed (or caused) to return to their previous state. The active flag can thus be checked accordingly to determine the previous state of the execution threads, and thereby determine how the execution threads should be handled.

For instance, any threads that were newly generated in response to the activation (enter_SIMD_state) instruction, i.e. because the execution lane was not active at the point at which the activation (enter_SIMD_state) instruction was executed, can accordingly be terminated once the set of one or more processing operations to be performed using the group of plural execution lanes has finished.

Thus, for any threads that are generated for lanes that were not active at the point at which the activation (enter_SIMD_state) instruction was executed, an indication that that the lane was previously inactive is in an embodiment carried through the processing operations (e.g. by setting an appropriate flag to indicate this), such that when the set of processing operations has finished, the execution threads can be suitably retired, i.e. and the execution lanes returned to their previous inactive state.

On the other hand, any threads that were actively executing a part of a program (whether that is the program that required the set of one or more processing operations to be performed, or a different part of the program) should be, and in an embodiment are, returned to their prior execution state, e.g. to continue their program execution.

Thus, for any threads that were previously active, whether for the program that is being executed by the thread group as a whole, or for a different part of the program, an indication of this is carried through (e.g. by setting the appropriate flag to indicate this), to allow the execution threads to return to their previous active execution state once the set of processing operations being performed by the group as a whole (e.g. in SIMD execution state) has finished.

To facilitate this operation, an indication of the current position of the execution thread in its respective program, e.g. in the form of a program counter for the program, at the point at which the activation (enter_SIMD_state) instruction is executed, is in an embodiment also stored for each execution thread that is caused to be in the active state.

In this way, for any threads that were executing a part of a program at the point at which the activation (enter_SIMD_state) instruction was executed, the current state of the program for those threads (e.g. the program counter) can be stored, and then suitably restored after the set of processing operations that are to be performed by the execution thread group as a whole have finished, and the execution of the program then continued accordingly (from its previous position once the SIMD state has finished).

For instance, in response to the activation instruction being executed, for any divergent threads that are to be brought into the active state, the current position (program counter) in the respective part of the program being executed by the divergent thread is in an embodiment stored such that when the thread is to be returned to its prior execution state execution of the program can continue accordingly from the previous position (e.g. rather than having to restart the program execution).

Thus, in embodiments, in response to executing the activation instruction: the method comprises: for any execution lanes executing an execution thread that has diverged from the program that requires the one or more processing operations to be performed: storing an indication of the current position of the part of the program being executed by the divergent thread such that the program execution can be continued once the one or more processing operations have been performed; and then causing the divergent execution thread to jump to the part of the program that requires the one or more processing operations to be performed.

As mentioned above, any associated data for the threads for the part of the program they are executing is in an embodiment also maintained and stored appropriately, e.g. such that it does not interfere with the processing operations being performed in the active state. In an embodiment any such data is written into an associated set of register file(s) for the execution thread (e.g., and in an embodiment, in a non-overlapping portion of the register file with the part(s) of the register file used for the activation (enter_SIMD_state) instruction) but this could also be written out, e.g. to memory, if desired.

The threads that were divergent and are brought into the active state, once in the active state, are in an embodiment then caused to jump to the set of instructions for performing the one or more processing operations that are to be performed using the group of plural execution lanes as a whole.

For instance, and in an embodiment, the set of instructions to perform the one or more processing operations are included in a sub-routine, such that causing the execution thread to start performing the one or more processing operations comprises causing the execution thread to jump to the start of the sub-routine. Thus, when the activation instruction is executed, after the execution threads have been made active (with any data written in/out for the threads as required) the threads are in an embodiment then all caused to jump to a new program location for the set of processing operations and start executing the set of processing operations.

Thus, in embodiments, in response to executing the activation instruction: the method comprises: causing all of the execution lanes in the group of execution lanes that are caused to be in the active state to jump to a sub-routine including the set of one or more instructions to perform the one or more processing operations that are to be performed using the group of plural execution lanes together.

In an embodiment an indication of a position of the sub-routine is included in the activation instruction itself, e.g. as an offset to a program counter indicating to a position in a program where the execution threads should jump once they are active. Thus, when the activation instruction is executed, the execution lanes can parse the instruction to read this indication to identify the position of the sub-routine and jump to that position accordingly. All of the execution lanes in the active state may thus be caused to jump to the start of the sub-routine and execute the instructions therein to perform the set of processing operations.

In that case, the current position (program counter) is in an embodiment also written out for any threads that were already active for the program that triggered the operation of the technology described herein. Again, this means that when the processing operations that are to be performed using the group of plural execution lanes as a whole have finished, the program execution can continue appropriately, e.g. after the one or more processing operations (the sub-routine) have been performed. (For threads already executing the program the data may in embodiments be retained since it may be valid for the processing operations, although this could also be stored, if desired, e.g. depending on the program in question.)

Thus, when the activation (enter_SIMD_state) instruction is executed, a current state of the execution threads is in an embodiment stored, e.g., and in an embodiment, to allow the execution threads to resume their current operation, e.g. program execution. This is in an embodiment done for all execution threads that exist at the point when the activation (enter_SIMD_state) instruction is executed, i.e. including those execution threads that are active for the program that requires the set of processing operations to be performed, but also those execution threads that may be performing a different part of the program, e.g. as they have diverged.

However, other arrangements would be possible. For instance, the set of instructions to perform the one or more processing operations could, for example, be included in the program directly after the activation (enter_SIMD_state) instruction, e.g. as the next instruction(s) in the program. In that case, any threads that were already actively executing the program (i.e. at least the thread that executed the activation instruction) can simply continue executing the program in sequence (without needing to jump or branch), in which case there is no need to do anything with the threads that were already active (other than store an indication that they were already active).

The activation (enter_SIMD_state) instruction thus causes any inactive lanes in the group of plural execution lanes to become active such that a corresponding group of execution threads can be executed using the group of plural execution lanes as a whole. A set of one or more processing operations can then be executed safe in the knowledge that all of the lanes are active at the point that the activation (enter_SIMD_state) instruction is executed.

Once the group of execution lanes is active, the set of processing operations can then be executed using the respective group of execution threads executing in the execution lanes accordingly. As mentioned above, in an embodiment the set of processing operations is executed by the group of execution threads in SIMD execution state. That is, in an embodiment, all of the execution threads are caused to perform the same processing operations, but for different input data points.

The set of processing operations that is performed using the execution thread group as a whole can include any suitable processing operations as desired. For instance, whilst it may be beneficial for all of the execution threads to be active at the start of the set of processing operations (and the technology described herein achieves this) it may not be necessary for all the execution threads in the group to remain active whilst the set of processing operations is being performed. Thus, the set of processing operations that are performed by the execution thread group as a whole may include, e.g., one or more conditional operations, such that threads may diverge/branch, and then re-converge, e.g., as required.

As mentioned above, after the set of one or more processing operations being performed in the active state have finished, the execution threads are then allowed to return to their previous state.

The execution threads may be returned to their previous state in any suitable and desired fashion, e.g. depending on the program that is being executed.

In embodiments, a further ‘deactivation’ (or ‘exit_SIMD_state’) instruction is provided that causes all of the execution threads in the group of execution threads to return to their previous state at the same time.

In that case the execution thread group exits the ‘active’ state as a whole. This means that if the execution threads had diverged during their active (SIMD) state operations, they should in an embodiment have re-converged by the point at which the further deactivation (exit_SIMD_state) instruction is executed

Thus, in embodiments, the method further comprises including (and the processing circuit is further arranged to include) in the program a further, deactivation instruction that when executed will cause all of the execution lanes in the active state to return to the processing state they were in prior to the activation instruction being executed. That is, in an embodiment, all of the execution threads are caused to return to their previous execution state together, at the same time. The deactivation instruction is thus in an embodiment included in the program subsequent to the activation instruction. In response to the execution lanes in the active state executing the deactivation instruction, all of the execution lanes in the group of plural execution lanes are thus caused to return to their prior processing state.

The use of this instruction to cause a whole group of execution threads that are being executed using a group of plural execution lanes together, e.g. in SIMD execution state, to exit such active (SIMD) execution state, e.g. and in an embodiment allow (or cause) the execution lanes to return to a previous execution state, may be novel and advantageous in its own right.

Thus, another embodiment of the technology described herein comprises a method of operating a graphics processor, the graphics processor comprising a programmable execution unit operable to execute programs to perform graphics processing operations, wherein the execution unit is configured as a plurality of execution lanes, wherein individual execution threads in a group of plural execution threads can be executed by respective execution lanes, the method comprising:

when a group of executing threads being executed by a group of plural execution lanes are executing a program in which the group of plural execution lanes are in an active state in which one or more processing operations are being performed using the group of plural execution lanes together:

in response to the execution threads in the active state executing a deactivation instruction:

causing the execution threads to exit the active state in which the processing operations can be performed using the plural execution lanes together.

A further embodiment of the technology described herein comprises a graphics processor comprising a programmable execution unit operable to execute programs to perform graphics processing operations, wherein the execution unit is configured as a plurality of execution lanes, wherein individual execution threads in a group of plural execution threads can be executed by respective execution lanes, wherein the execution unit is configured such that:

when a group of executing threads being executed by a group of plural execution lanes are executing a program in which the group of plural execution lanes are in an active state in which one or more processing operations are being performed using the group of plural execution lanes together:

in response to the execution threads in the active state executing a deactivation instruction in the program:

the execution threads executing in the execution lanes are caused to exit the active state in which the processing operations can be performed using the plural execution lanes together.

These embodiments also extend to a method of operating a graphics processing system (and to corresponding the operation of a graphics processing system) including a graphics processor, wherein the graphics processor comprises a programmable execution unit operable to execute programs to perform graphics processing operations, wherein the execution unit is configured as a plurality of execution lanes, wherein individual execution threads in a group of plural execution threads can be executed by respective execution lanes; the method comprising:

including in a program to be executed by a group of plural execution threads, wherein the program comprises a set of one or more instructions to cause one or more processing operations to be performed using a group of plural execution lanes together, subsequent to the set of one or more instructions that cause the one or more processing operations to be performed using a group of plural execution lanes together, a deactivation instruction that when executed by the execution threads in the group of plural execution lanes will cause the execution threads to exit the active state in which the processing operations can be performed using the plural execution lanes together; the method further comprising:

when a group of executing threads being executed by a group of plural execution lanes are executing a program in which the group of plural execution lanes are in an active state in which one or more processing operations are being performed using the group of plural execution lanes together, in response to the execution threads in the active state executing the deactivation instruction:

causing the execution threads to exit the active state in which the processing operations can be performed using the plural execution lanes together.

As will be appreciated by those skilled in the art, these additional embodiments of the technology described herein relating to the deactivation (exit_SIMD_state) instruction can, and in an embodiment do, include any one or more or all of the features of the technology described herein described herein, as appropriate.

For example, and in an embodiment, when the deactivation (exit_SIMD_state) instruction is executed, the execution threads in the group of plural execution lanes that are caused to exit the active (e.g. SIMD) state, are then returned to their previous execution state, e.g. as explained above.

Thus, when the deactivation (exit_SIMD_state) instruction is executed, any processing state (information) or other data that was stored for the execution threads when the activation (enter_SIMD_state) instruction was executed may then be restored appropriately, e.g. to allow the execution threads to return to their previous execution state. For example, the position that the execution thread had reached in its respective program (the program counter) may be restored to allow the execution thread to continue its program execution from this point. Or, if the execution lane was previously inactive, such that there was no previous execution thread, the execution thread can be terminated accordingly.

In embodiments the deactivation (exit_SIMD_state) instruction is always included in the shader program as a pair in combination with an activation (enter_SIMD_state) instruction. That is, in some embodiments, the activation (enter_SIMD_state) instruction is always eventually followed by a corresponding deactivation (exit_SIMD_state) instruction, e.g. after the set of processing operations have finished.

However, this need not be the case and it is also contemplated that the activation (enter_SIMD_state) instruction may be repeatedly executed, for instance.

Likewise, it would also be possible to use other arrangements for retiring the execution threads from the active state without including an explicit instruction to cause all of the execution threads to return to their previous state together. For instance, in embodiments, execution threads may be retired individually. Various other arrangements would be possible.

The effect of all of this is therefore to provide an efficient approach for activating a group of execution threads using a single instruction that when executed brings a whole group of execution threads into the same active state.

The technology described herein may therefore provide various improvements compared to other approaches.

The operation of the technology described herein is triggered by including appropriate instructions into a shader program, as described above. Such instructions can be included in a shader program to be executed by the programmable execution unit in any suitable and desired manner and by any suitable and desired element of the overall data (graphics) processing system, e.g. depending on how the shader programs are generated.

In an embodiment, it or they is generated by a compiler (the shader compiler) for the graphics processor of the graphics processing system in question (and thus the processing circuit that generates the shading program in an embodiment comprises an appropriate compiler circuit). The compiler is in an embodiment executed on an appropriate programmable processing circuit of the graphics processing system.

The compilation process (the compiler) can generate the shader program in any suitable and desired manner, e.g., and in an embodiment, using any suitable and desired compiler techniques for that purpose.

Thus, in embodiments, the activation (enter_SIMD_state) instruction is included in a shader program that is to be executed by the graphics processor by the compiler in response to an appropriate indication that a set of processing operations are to be performed using a group of plural execution lanes together, e.g. in a SIMD execution state.

Thus, e.g., and in an embodiment, an application program will be able to include an explicit indication of a need for a set of one or more processing operations to be performed (e.g.) in SIMD execution state, with the compiler then, in the technology described herein, including an appropriate activation (enter_SIMD_state) instruction (and in an embodiment also a corresponding deactivation (exit_SIMD_state) instruction) in the compiled shader program in response to that. It may also be possible for the compiler to include an appropriate activation (enter_SIMD_state) instruction of its own accord, e.g. in the case where the compiler is able to assess the shader program being compiled to identify when and where to include such instructions, even in the absence of an explicit indication of that.

In an embodiment, the compiler analyses the shader program code that is provided, e.g. by the application on the host processor that requires the graphics processing, and includes an appropriate activation (enter_SIMD_state) instruction at the appropriate point(s) in the shader program (e.g. by inserting the instruction(s) in the (compiled) shader program).

The technology described herein also extends to and includes such operation of a compiler. Thus, a further embodiment of the technology described herein comprises a method of compiling a shader program to be executed by a programmable execution unit of a graphics processor comprising a programmable execution unit operable to execute programs to perform graphics processing operations, wherein the execution unit is configured as a plurality of execution lanes, wherein individual execution threads in a group of plural execution threads can be executed by respective execution lanes; the method comprising:

including in a program to be executed by a group of plural execution threads, an activation instruction that when executed by an execution thread in the group of execution threads will cause a group of plural execution lanes to be in an ‘active’ state in which processing operations can be performed using the plural execution lanes together; and

including in the program, subsequent to the activation instruction that will cause the group of plural execution lanes to be in the ‘active’ state, a set of one or more instructions to cause one or more processing operations to be performed using the group of plural execution lanes together.

A further embodiment of the technology described herein comprises a compiler for compiling a shader program to be executed by a programmable execution unit of a graphics processor comprising a programmable execution unit operable to execute programs to perform graphics processing operations, wherein the execution unit is configured as a plurality of execution lanes, wherein individual execution threads in a group of plural execution threads can be executed by respective execution lanes; the compiler comprising a processing circuit configured to:

include in a program to be executed by a group of plural execution threads, an activation instruction that when executed by an execution thread in the group of execution threads will cause a group of plural execution lanes to be in an ‘active’ state in which processing operations can be performed using the plural execution lanes together; and include in the program, subsequent to the activation instruction that will cause the group of plural execution lanes to be in the ‘active’ state, a set of one or more instructions to cause one or more processing operations to be performed using the group of plural execution lanes together.

The compiler is in an embodiment also operable to include the deactivation (exit_SIMD_state) instructions, where these are used. Thus, there is also provided a method of compiling a shader program (and a corresponding compiler for compiling a shader program) to be executed by a programmable execution unit of a graphics processor comprising a programmable execution unit operable to execute programs to perform graphics processing operations, wherein the execution unit is configured as a plurality of execution lanes, wherein individual execution threads in a group of plural execution threads can be executed by respective execution lanes; the method comprising:

including in a program to be executed by a group of plural execution threads, wherein the program comprises a set of one or more instructions to cause one or more processing operations to be performed using a group of plural execution lanes together, subsequent to the set of one or more instructions that cause the one or more processing operations to be performed using a group of plural execution lanes together, a deactivation instruction that when executed by the execution threads in the group of plural execution lanes will cause the execution threads to exit the active state in which the processing operations can be performed using the plural execution lanes together.

This step may be performed as part of the method of compiling a shader program described above, e.g. together with the steps of including the activation instruction. However, this may also be novel and advantageous in its own right, and the technology described herein therefore also extends to such a method itself.

The compiler (the compiler processing circuit) is in an embodiment part of, and in an embodiment executes on, a central processing unit (CPU), such as a host processor, of the graphics processing system, and is in an embodiment part of a driver for the graphics processor that is executing on the CPU (e.g. host processor).

In this case, the compiler and compiled code will run on separate processors within the overall graphics processing system. However, other arrangements would be possible, such as the compiler running on the same processor as the compiled code, if desired.

The compilation process (the compiler) can generate the shader program in any suitable and desired manner, e.g., and in an embodiment, using any suitable and desired compiler techniques for that purpose.

Thus, in an embodiment, the shader program is generated by the compiler, and the compiler is arranged to include within the shader program the instructions that are used in the technology described herein. Other arrangements would, of course, be possible.

The generated shader program can then be issued to the programmable execution unit of the graphics processor for execution thereby.

The technology described herein also extends to the operation of the graphics processor itself when executing the shader program. According to another embodiment of the technology described herein there is provided a method of operating a graphics processor, the graphics processor comprising a programmable execution unit operable to execute programs to perform graphics processing operations, wherein the execution unit is configured as a plurality of execution lanes, wherein individual execution threads in a group of plural execution threads can be executed by respective execution lanes, the method comprising:

when a program to perform a set of one or more processing operations is being executed by an execution thread, in response to the execution thread executing an activation instruction in the program:

causing a group of plural execution lanes to be in an ‘active’ state in which active state processing operations can be performed using the group of plural execution lanes together; and then performing the set of one or more processing operations using the group of plural execution lanes together.

A further embodiment of the technology described herein comprises a graphics processor comprising a programmable execution unit operable to execute programs to perform graphics processing operations, wherein the execution unit is configured as a plurality of execution lanes, wherein individual execution threads in a group of plural execution threads can be executed by respective execution lanes, wherein the execution unit is configured such that:

when a program to perform a set of one or more processing operations is being executed by an execution thread, in response to the execution thread executing an activation instruction in the program:

a group of plural execution lanes is caused to be in an ‘active’ state such that the execution unit can then perform the set of one or more processing operations using the group of plural execution lanes together.

Thus, as described above, when a program is being executed by an execution thread (or a group of execution threads), and an execution thread (in the group of execution threads) executes the activation instruction, a group of plural lanes are then caused to be an in ‘active’ state together, such that they are available as a whole to perform a subsequent set of one or more processing operations.

As will be appreciated by those skilled in the art, these additional embodiments of the technology described herein relating to the operation of the compiler and/or the graphics processor can, and in an embodiment do, include any one or more or all of the features of the technology described herein described herein, as appropriate.

For instance, in embodiments, the method further comprises, after performing the set of one or more processing operations using the group of plural execution lanes together, in response to the execution threads executing a deactivation (exit_SIMD_state) instruction: causing the execution threads to exit the active state in which the processing operations can be performed using the plural execution lanes together, e.g., and in an embodiment, such that the execution threads are returned to their previous execution state.

The graphics processor can be any suitable and desired graphics processor that includes a programmable execution unit that can execute program instructions.

The programmable execution unit of the graphics processor can be any suitable and desired programmable execution unit that is operable to execute shader programs. The graphics processor may comprise a single programmable execution unit, or may have plural execution units. Where there are a plural execution units, each execution unit can, and in an embodiment does, operate in the manner of the technology described herein.

Where there are plural execution units, each execution unit may be provided as a separate circuit to other execution units of the data processor, or the execution units may share some or all of their circuits (circuit elements).

The (and each) execution unit should, and in an embodiment does, comprise appropriate circuits (processing circuits/logic) for performing the operations required of the execution unit.

Thus, the (and each) execution unit will, for example, and in an embodiment does, comprise a set of at least one functional unit (circuit) operable to perform data processing operations for an instruction being executed by an execution thread. An execution unit may comprise only a single functional unit, or could comprise plural functional units, depending on the operations the execution unit is to perform.

The functional unit or units can comprise any desired and suitable functional unit or units operable to perform data processing operations in response to and in accordance with program instructions. Thus the functional unit or units in an embodiment comprise one or more or all of: arithmetic units (arithmetic logic units) (add, subtract, multiply, divide, etc.), bit manipulation units (invert, swap, shift, etc.), logic operation units (AND, OR, NAND, NOR, NOT, XOR, etc.), load-type units (such as varying, texturing or load units in the case of a graphics processor), store type units (such as blend or store units), etc.

In an embodiment, the graphics processor and the programmable execution unit is operable to execute shader programs for groups (“warps”) of plural execution threads together, e.g., and in an embodiment, in single instruction, multiple data (SIMD) execution state, and the group of one or more execution threads that are together brought into the active state comprises such a thread group (warp). However, other arrangements would in principle be possible. For instance, the plural execution lanes could execute threads in, e.g., a single instruction, multiple thread (SIMT) state, where execution threads execute program in lockstep, e.g. one instruction at a time, but execution threads can still perform different processing operations.

In the case where execution threads can be grouped into thread groups (warps) in the manner discussed above, the functional units, etc., of the programmable execution unit are in the technology described herein configured and operable so as to facilitate such thread group arrangements. Thus, for example, the functional units are arranged as respective execution lanes, e.g. one for each thread that a thread group (warp) may contain (such that, for example, for a system in which execution threads are grouped into groups (warps) of eight threads, the functional units may be operable as eight respective (and identical) execution lanes), so that the programmable execution unit can execute the same instruction in parallel for each thread of a thread group (warp).

It is the state of these execution lanes that are managed using the instructions of the technology described herein.

The group of plural execution lanes that can be made active (or not active) according to the technology described herein can be any suitable and desired group of plural execution lanes. For instance, the group of execution lanes may comprise two or more execution lanes, such as four, eight or sixteen (or more, such as 32, 64 or 128) execution lanes.

In an embodiment the group of plural execution lanes that can be made active (or not active) according to the technology described herein corresponds to the group of all of the execution lanes. For instance, where the execution unit is configured such that there is a respective execution lane for each thread in a thread group (warp) of a desired size, in an embodiment all of the execution lanes are caused to be in an active state together, such that the set of processing operations are then performed using a whole thread group that performs a set of processing operations together, e.g., and in an embodiment in SIMD execution state.

However, in principle, any suitable group of plural execution lanes may be caused to be in the active state and used accordingly in the manner described herein. For example, it may be the case that the processing unit is configured to have more execution lanes than the number of threads in a given execution thread group (warp) size. In that case, it may be desirable to only use a subset, e.g. half, of the available execution lanes. Various other arrangements would be possible.

The graphics processor in an embodiment also comprises any other appropriate and desired units and circuits required for the operation of the programmable execution unit(s), such as appropriate control circuits (control logic) for controlling the execution unit(s) to cause and to perform the desired and appropriate processing operations.

Thus the graphics processor in an embodiment also comprises an appropriate thread group execution controller (scheduler) circuit, which is operable to issue thread groups to the programmable execution unit for execution and to control the scheduling of thread groups on/to the programmable execution unit for execution.

In an embodiment, the graphics processor comprises one or more of, and in an embodiment all of: an instruction decode circuit or circuits operable to decode instructions to be executed; an instruction issue circuit or circuits operable to issue instructions to be executed to the programmable execution unit so as to cause the execution unit to execute the required instructions for a thread group; an instruction fetch circuit or circuits operable to fetch instructions to be executed (prior to the decode circuit(s)); an instruction cache for storing instructions locally to the programmable execution unit for execution by execution threads being executed by the programmable execution unit; an execution thread generator (spawner) circuit that generates (spawns) (groups of) threads for execution; and an execution thread scheduler circuit that schedules (groups of) threads for execution (this may be part of the thread generator).

As well as the programmable execution unit, the graphics processor includes a group of plural registers (a register file) operable to and to be used to store data for execution threads that are executing. Each thread of a group of one or more execution threads that are executing a shader program will have an associated set of registers to be used for storing data for the execution thread (either input data to be processed for the execution thread or output data generated by the execution thread) allocated to it from the overall group of registers (register file) that is available to the programmable execution unit (and to execution threads that the programmable execution unit is executing).

Where there are plural execution units, each execution unit may have its own distinct group of registers (register file), or there may be a single group of registers (register file) shared between plural (e.g. some or all) of the separate execution units.

The group(s) of registers (register file(s)) can take any suitable and desired form and be arranged in any suitable and desired manner, e.g., as comprising single or plural banks, etc.

The graphics processor will correspondingly comprise appropriate load/store units and communication paths for transferring data between the registers/register file and a memory system of or accessible to the graphics processor (e.g., and in an embodiment, via an appropriate cache hierarchy).

Thus the graphics processor in an embodiment has an appropriate interface to, and communication with memory (a memory system) of or accessible to the graphics processor.

The memory and memory system is in an embodiment a main memory of or available to the graphics processor, such as a memory that is dedicated to the graphics processor, or a main memory of a data processing system that the graphics processor is part of. In an embodiment, the memory system includes an appropriate cache hierarchy intermediate the main memory of the memory system and the programmable execution unit(s) of the graphics processor.

The technology described herein has been described above with reference to the operation of the graphics processor in general. In the case where the graphics processor includes multiple processing cores, then each processing core can, and in an embodiment does, operate in the manner of the technology described herein (i.e. such that each processing core has its own respective execution processing circuit, thread issuing circuit, etc., all of which are operable in the manner of the technology described herein).

In some embodiments, the graphics processor comprises, and/or is in communication with, one or more memories and/or memory devices that store the data described herein, and/or store software for performing the processes described herein. The graphics processor may also be in communication with a host microprocessor, and/or with a display for displaying images based on the data generated by the graphics processor.

In an embodiment, the graphics processor is part of an overall data processing system that comprises one or more memories and/or memory devices and a host processor (and, optionally, a display). In an embodiment, the host microprocessor is operable to execute applications that require data processing by the graphics processor, with the graphics processor operating in the manner of the technology described herein when required to process data by applications executing on the host processor.

Other arrangements would, of course, be possible. The graphics processor of the technology described herein can be used for all forms of output that a graphics processor (and processing pipeline) may be used to generate. For example, in the case of graphics processing operations, the graphics processor may generate frames for display, render-to-texture outputs, etc. The output data values from the processing are in an embodiment exported to external, e.g. main, memory, for storage and use, such as to a frame buffer for a display. In an embodiment, the graphics processor is used for performing ray tracing operations. However, the graphics processor may be used for any suitable rendering scheme. Moreover, the graphics processor need not perform graphics processing operations but may also be configured to perform general purpose graphics processing operations.

The technology described herein is thus applicable to any suitable form or configuration of graphics processor and data processing system. In an embodiment, the various functions of the technology described herein are carried out on a single data processing platform that generates and outputs data (such as rendered fragment data that is, e.g., written to the frame buffer), for example for a display device.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, unless otherwise indicated, the various functional elements and stages of the technology described herein may comprise a suitable processor or processors, controller or controllers, functional units, circuitry/circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Subject to any hardware necessary to carry out the specific functions discussed above, the data processing system and pipeline can otherwise include any one or more or all of the usual functional units, etc., that data processing systems and pipelines include.

It will also be appreciated by those skilled in the art that all of the described embodiments of the technology described herein can, and in an embodiment do, include, as appropriate, any one or more or all of the features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a processor, renderer or microprocessor system comprising data processor causes in conjunction with said data processor said processor, renderer or microprocessor system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CD-ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A number of embodiments of the technology described herein will now be described in the context of the processing of computer graphics for display by a graphics processor. However, it will be appreciated that the techniques for handling groups of execution threads described herein can be used in other non-graphics contexts in which groups of threads are used.

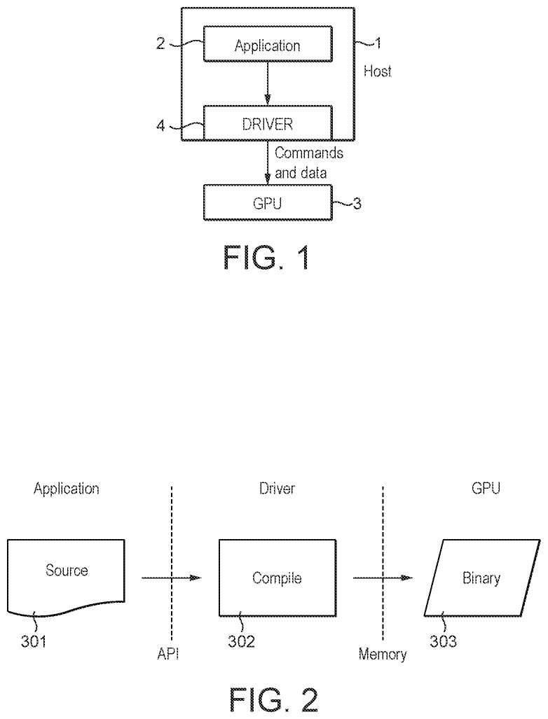

FIG. 1 shows a typical graphics processing system. An application 2, such as a game, executing on a host processor 1 will require graphics processing operations to be performed by an associated graphics processing unit (GPU) (graphics processor) 3. To do this, the application will generate API (Application Programming Interface) calls that are interpreted by a driver 4 for the graphics processor 3 that is running on the host processor 1 to generate appropriate commands to the graphics processor 3 to generate graphics output required by the application 2. To facilitate this, a set of “commands” will be provided to the graphics processor 3 in response to commands from the application 2 running on the host system 1 for graphics output (e.g. to generate a frame to be displayed).

To do this, the application 2 provides the shader programs implemented using a high-level shader programming language, such as GLSL, HLSL, OpenCL, etc. These shader programs are then translated by a shader language compiler to binary code for the target graphics processing pipeline 33. This may include the creation of one or more intermediate representations of the program within the compiler. The compiler may, e.g., be part of the driver 4, with there being a special API call to cause the compiler to run. The compiler execution can thus be seen as being part of the draw call preparation done by the driver in response to API calls generated by an application. (Other compiler arrangements would, of course, be possible.)

FIG. 2 illustrates this, and shows the shader program being provided in the high level shader programming language 301 by the application 2 to the driver 4, which then compiles 302 the shader program to the binary code 303 for the graphics processing pipeline 33.

As discussed above, each shader in the graphics processing pipeline is a processing stage that performs graphics processing by running small programs for each “work” item in a graphics output to be generated (an “item” in this regard is usually a vertex, or a sampling position). For each work item to be processed, an execution thread that will execute the corresponding shader program is issued to appropriate programmable processing circuit(s) that then executes the shader program for the execution thread in question.

In such arrangements, in order to execute the execution threads of a thread group, e.g., so as to perform a fragment shading operation, the execution threads of a thread group will be appropriately issued to appropriate functional units, such as arithmetic processing units, to perform the processing operations required by the shader program in question. In the case where threads can be organised into and executed as respective thread groups of plural threads, then typically the functional units will be arranged as plural execution lanes, with each execution lane being able to perform processing operations for an execution thread of a thread group.

As such, each functional unit (or set of associated functional units) will be arranged and operable as a plurality of execution lanes, to which threads of a thread group can be issued for execution. When a thread group is to be executed, appropriate control logic will issue the relevant data and instruction to be executed to the appropriate execution lanes of a functional unit or set of functional units, so that the instruction in question can be executed for the threads of the thread group by the functional unit(s).

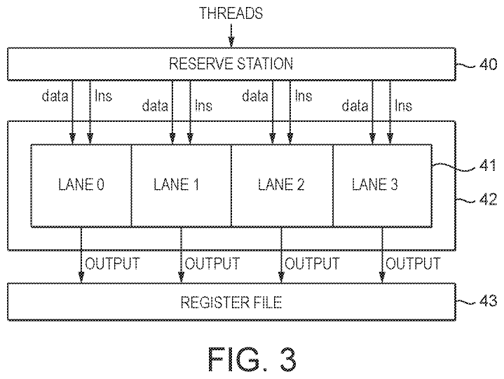

FIG. 3 illustrates this, and shows an execution processing circuit 42 arranged as four execution lanes 41, and appropriate control logic (circuit) in the form of a “reserve station” 40 for issuing the appropriate data and an instruction for each thread of a thread group to an execution lane 41 of the set of execution lanes, according to the present embodiments. (The reserve station (control logic) 40 will receive threads for execution, e.g., from a thread spawner or a thread spawning process of the graphics processor.) It will be appreciated that in other embodiments, the execution processing circuit 42 may be arranged as fewer than or more than four execution lanes, e.g. two or eight.

The functional units may comprise, for example, one or more or all of: arithmetic units (arithmetic logic units) (add, subtract, multiply, divide, etc.), bit manipulation units (invert, swap, shift, etc.), logic operation units (AND, OR, NAND, NOR, NOT, XOR, etc.), load-type units (such as varying, texturing or load units in the case of a graphics processor), store-type units (such as blend or store units), etc.

Each execution lane 41 of the execution processing circuit 42 also has access to (and available to it) a set of plural registers 43 for storing data values associated with and for the execution lane (i.e. for storing data values being processed for the execution thread that the execution lane is currently executing). This then facilitates the handling of execution threads and their data values in an execution lane without the need to (always) require access to memory (to the memory system of the graphics processing system). The registers for the execution lanes can be arranged in register file banks, as desired, and as appropriate.

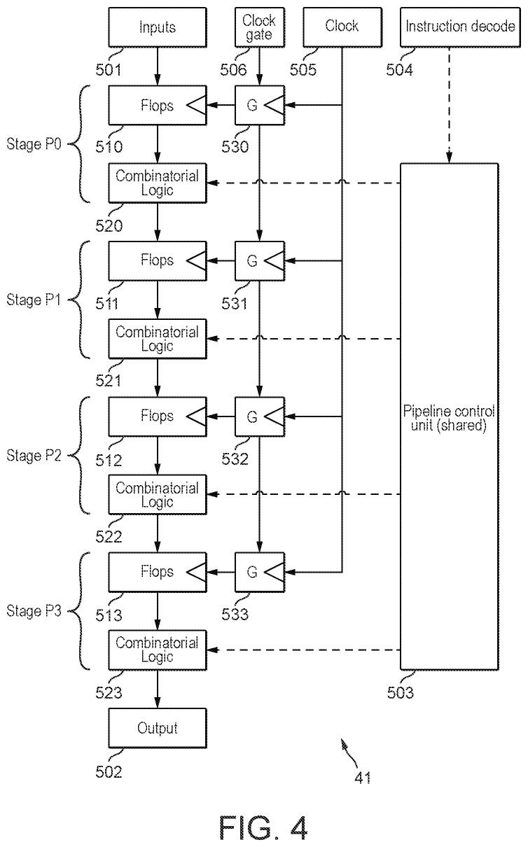

FIG. 4 shows in more detail an execution lane 41 in the form of an arithmetic unit pipeline of a graphics processor 3, which can perform arithmetic processing operations for an execution thread that has been issued to it for execution by control logic 40, according to the present embodiment.

The pipeline 41 of FIG. 4 is operable to perform a graphics processing operation on an input data value, and then provide the result of the processing operation as an output data value. The input data value is stored as a binary data value in an input register 501, and the output data value is stored as a binary data value in an output register 502.

The processing operation that the pipeline is operable to perform can be any suitable processing operation, and in the present embodiment is performed as a series of four processing operations. Thus, as shown in FIG. 4, in the present embodiment, the pipeline 41 is arranged as a pipeline (series) of four arithmetic processing stages P0-P3, with each arithmetic processing stage P0-P3 being operable to execute one instruction during a cycle of clock 505. It will be appreciated that in other embodiments, the “depth” of the pipeline may be fewer or more than four processing stages, such as two or eight processing stages.

As shown in FIG. 4, at each processing stage P0-P3, a binary data value stored in flip-flops (latches) 510-513 is provided as an input to a combinatorial logic circuit 520-523 (functional unit), and the combinatorial logic circuit 520-523 (functional unit) then performs an e.g. arithmetic operation on the input to produce a binary output. The output of a combinatorial logic circuit 520-523 may then be stored in flip-flops (latches), and may be provided as the input to the next stage (functional unit), and so on. The final output data value of the pipeline is the output of the combinatorial logic circuit 523 (functional unit) of the final stage P3 of the pipeline 41.

As shown in FIG. 4, the pipeline (execution lane) 41 is operated under the control of a pipeline control unit 503, which indicates to the combinatorial logic circuit 520-523 (functional unit) at each stage P0-P3 the operation that is to be performed during a clock cycle, e.g. by issuing appropriate opcodes to the combinatorial logic circuits 520-523. The pipeline control unit 503 is in turn controlled by instruction decode circuit 504, which operates to decode an instruction in the shader program being executed, and to cause the pipeline control unit 503 to control the pipeline (execution lane) 41 to perform the required graphics processing operation(s) to execute the shader instruction in question.

The pipeline 41 may also include clock gates 530-533 for performing clock gating, under the control of clock gate control circuit 506, as will be discussed further below.

FIG. 4 shows only a single execution lane 41 in detail for the sake of clarity. However, in the present embodiment, the execution processing circuit 42 is arranged as four execution lanes 41, with the instruction decode circuit 504 and pipeline control circuit 503 then being shared across the four execution lanes 41 collectively, such that a single instruction in the shader program is decoded, and then executed by all of the four execution lanes in a given cycle. Thus, instructions in the shader program are executed over a physical SIMD (single instruction, multiple data) arithmetic data path.

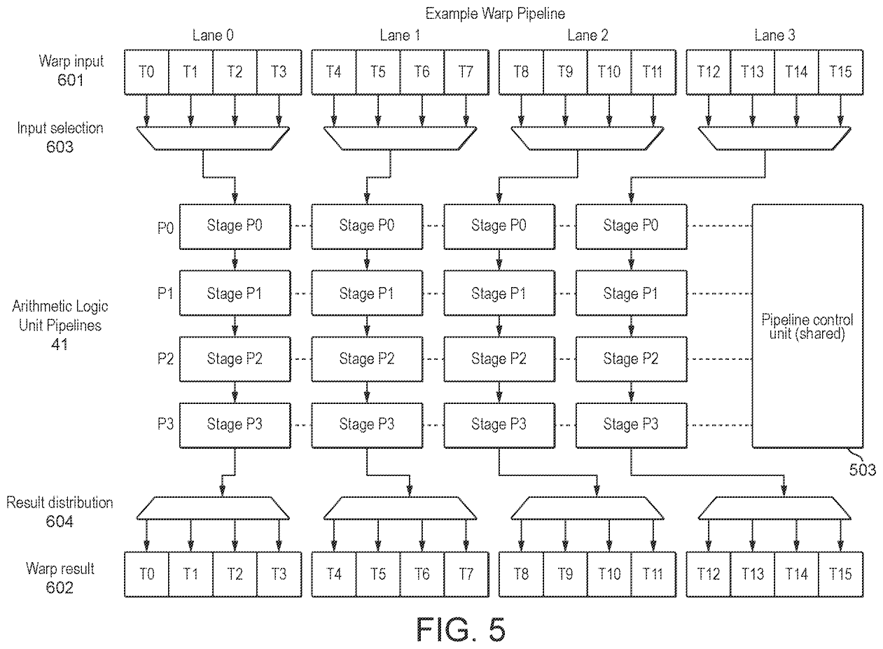

This is illustrated in FIG. 5. As shown in FIG. 5, in the present embodiment, the execution processing circuit 42 is arranged as four execution lanes, Lane0-Lane3, which are provided by four arithmetic unit pipelines 41, each comprising four stages P0-P3, which operate under the control of the (shared) pipeline control circuit 503, as discussed above with reference to FIG. 4.

As discussed above, it may typically be the case that threads are arranged into groups (“warps”) that match the number of execution lanes that are provided, in which case (in arrangements not forming part of the technology described herein) each thread within a thread group can be issued to a respective one of the execution lanes for execution, i.e. such that an execution lane has only one execution thread from a thread group (“warp”) issued to it. Such arrangements can allow each shader program instruction to be executed for all threads in a thread group in a single cycle, such that single-threaded execution performance can be increased, for example.

The present embodiments relate to systems where threads that are to execute a shader program can be organised into groups (“warps”) of threads that can be used to perform processing operations together in a single instruction, multiple data (SIMD) execution state.

In this respect, the present inventors have recognised that at a given processing instant when the instructions that are to be executed in SIMD execution state fall, the execution lanes may not currently be active.

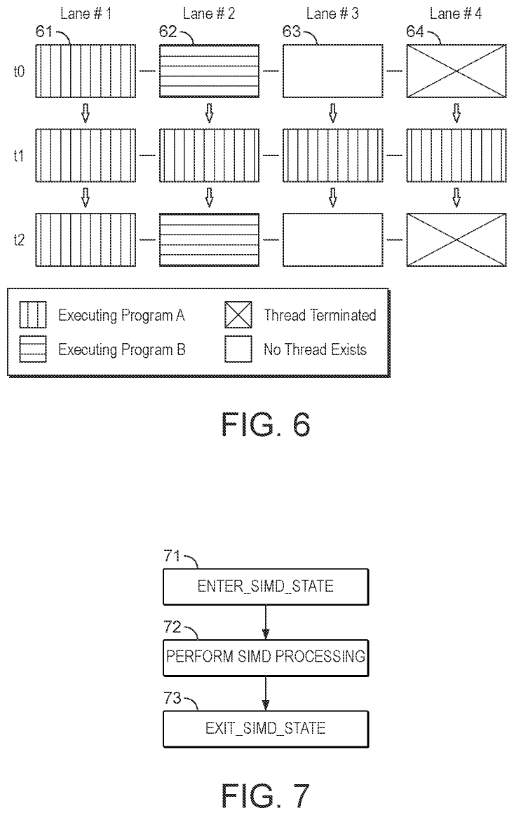

For instance, referring to FIG. 6, it may be the case that at the point at which the SIMD execution is required, the execution lanes may be in a number of different states. For instance, a first execution lane 61 may be active for the program that requires the SIMD execution processing to be performed such that an execution thread in the first execution lane 61 is executing the part of the program (program A) that requires the SIMD operations to be performed. However, another execution lane 62 may be executing a thread that is performing a different part of the program (program B), e.g. in response to an earlier divergence of the program. Other execution lanes may be inactive, e.g., either because an execution thread was never generated (execution lane 63) or because the execution thread they were executing has been terminated (execution lane 64). Thus, at a first instance in time, t0, the execution lanes may be in different execution states

The present embodiments thus provide an instruction, referred to herein as an ‘enter_SIMD_state’ instruction that when executed will cause all of the execution lanes to be in the required active state for performing the SIMD execution processing. FIG. 7 shows the high level operation according to the present embodiment. Thus, when the ‘enter_SIMD_state’ instruction is executed (step 71), all of the execution lanes are then brought into the active state. At this point, all of the execution lanes are then active and performing the same operations (for the same part of the program), as shown in FIG. 6, at instance t1. The desired SIMD processing operations can then be performed using the group of execution lanes as a whole (step 72). Once the SIMD processing operations have finished, an appropriate ‘exit_SIMD_state’ instruction can then be executed (step 73) that causes the execution lanes to return to their previous execution state. Thus, as shown in FIG. 6, at instance t2, after the SIMD processing is finished, the execution lanes are returned to their original execution state.

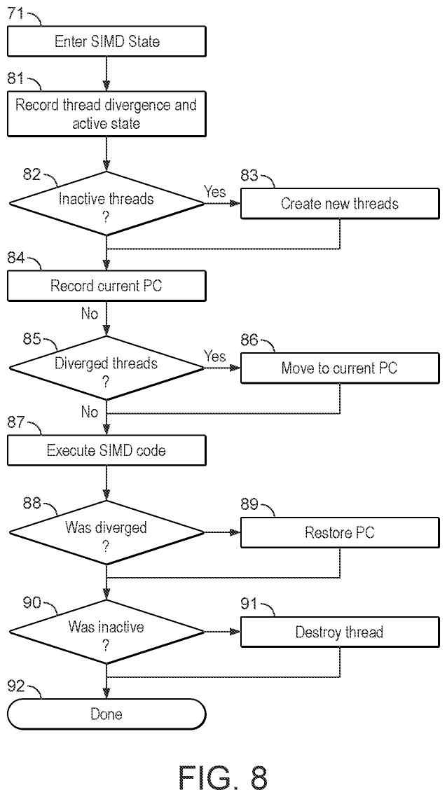

FIG. 8 shows in more detail the operation according to the present embodiments in response to the ‘enter_SIMD_state’ instruction being executed (step 71). Depending on the execution state of an execution lane at the point at which the ‘enter_SIMD_state’ instruction is executed, different operations may need to be performed, e.g. in order to allow the execution threads to return to their previous execution state after the SIMD processing operations have finished.

Accordingly, for each execution lane, the execution state i.e. is the execution thread in the execution active or not active, has there been a divergence, etc., is recorded (step 81). It is then determined whether there any execution lanes are inactive execution threads (step 82). If so, in order to bring the execution lane into the desired active state for the SIMD processing operations, a new execution thread is generated in that execution lane (step 83). The execution thread can then be suitably initialised for the SIMD processing operations, e.g. with a set of zero values. An indication that the execution lane was inactive is also stored and carried through the SIMD processing operations.

For any active threads, the current program counter is stored (step 84) in order to allow the execution threads to return to their current position once the SIMD processing operations have finished. Likewise, for any diverged threads (step 85), the current program counter is stored, and the diverged thread is then moved to the current program counter (step 86) for the program that requires the SIMD processing operations.

At this point all of the execution lanes are in the desired active state for performing the SIMD processing operations and the SIMD processing operations can be performed accordingly using the whole warp in SIMD state (step 87). After the SIMD processing operations have finished, the threads can then be returned to their previous execution state. As mentioned above, this is in an embodiment done by executing an appropriate ‘exit_SIMD_state’ instruction (step 73 in FIG. 7) that causes all of the execution threads to exit the active SIMD state together. In response to executing the exit_SIMD_state’ instruction, the execution threads can then be returned to their previous execution state.

Thus, for any threads that were diverged (step 88), their program counter is restored (step 89), and their previous program execution can continue. Likewise, any threads that were already active can continue their program execution. On the other hand, for any threads that were inactive at the point at which the ‘enter_SIMD_state’ instruction was executed (step 90), the thread can be destroyed (step 91).

The SIMD processing is then completed and the program execution can continue as desired (step 92). As will be appreciated from the above, the operation of the present embodiments involves executing appropriate shader programs to perform the desired processing operations. In the present embodiments, these shader programs are generated by a compiler for the graphics processor 3, e.g. that is executing on a central processing unit (CPU), such as a host processor 1, of the graphics processing system (and in an embodiment as part of the driver 4 operation for the graphics processor, as shown in FIG. 1).

The compiler (driver) will receive the high level shader program or programs to be executed from the application 2 that requires the processing to be performed, and then compile that program or programs into appropriate shader programs for execution by the graphics processor, and, as part of this processing, will, as discussed above, include in one or more of the compiled shader programs to be executed by the graphics processor, appropriate ‘enter_SIMD_state’ and ‘exit_SIMD_state’ instructions to cause the execution lanes to enter or exit the SIMD active execution state as desired.

The compilation process (the compiler) can use any suitable and desired compiler techniques for this.

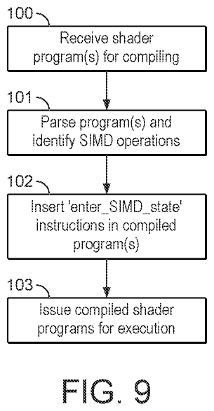

FIG. 9 shows an embodiment of the compilation process.

As shown in FIG. 9, the compiler for the graphics processor will receive a program or programs for compiling (step 100). The compiler will then analyse the shader program code that is provided, to identify instances of required SIMD processing in that shader program code (step 101), and to insert corresponding ‘enter_SIMD_state’ and ‘exit_SIMD_state’ instructions at the appropriate point(s) in the compiled shader program(s) (step 102).

The compiled shader programs will then be issued to the graphics processor for execution (e.g. stored in appropriate memory of and/or accessible to the graphics processor, so that the graphics processor can fetch the required shader programs for execution as required) (step 103).

It can be seen from the above that the technology described herein, in its embodiments at least, can provide a more efficient process for controlling a whole warp's worth of execution lanes to transition from an arbitrary processing state to a desired SIMD execution state, in which a set of SIMD processing operations can be performed using the whole warp together, before the execution lanes can then be returned to their previous state, appropriately.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a graphics processor, the graphics processor comprising a programmable execution unit operable to execute programs to perform graphics processing operations, wherein the execution unit is configured as a plurality of execution lanes, wherein individual execution threads in a group of plural execution threads can be executed by respective execution lanes,
the method comprising:
when a program to perform a set of one or more processing operations is being executed by an execution thread, in response to the execution thread executing an activation instruction:
causing a group of plural execution lanes to be in an active state in which active state processing operations can be performed using the group of plural execution lanes together; and then
performing the set of one or more processing operations using the group of plural execution lanes together.

2. The method of claim 1, comprising: allowing the execution lanes to return to their previous execution state once the one or more processing operations that are performed using the group of plural execution lanes together have finished.

3. The method of claim 1, wherein in response to executing the activation instruction: the method comprises: for each execution lane in the group of plural execution lanes that is caused to be in the active state: determining an execution state of the execution lane at the point prior to which the activation instruction was executed; and storing an indication of the prior execution state such that the execution lanes can be returned to their prior execution once the set of one or more processing operations using the group of plural execution lanes together has finished.

4. The method of claim 1, wherein in response to executing the activation instruction: the method comprises: for any execution lanes that are not active at the point at which the activation instruction is executed: generating a new execution thread for executing the set of one or more processing operations.

5. The method of claim 1, wherein in response to executing the activation instruction: the method comprises: for any execution lanes executing an execution thread that has diverged from the program that requires the one or more processing operations to be performed: storing an indication of the current position of the part of the program being executed by the divergent thread such that the program execution can be continued once the one or more processing operations have been performed; and then causing the divergent execution thread to jump to the part of the program that requires the one or more processing operations to be performed.

6. The method of claim 1, wherein in response to executing the activation instruction: the method comprises: causing all of the execution lanes in the group of execution lanes that are caused to be in the active state to jump to a sub-routine including the set of one or more instructions to perform the one or more processing operations that are to be performed using the group of plural execution lanes together, wherein an indication of a position of the sub-routine is included in the activation instruction.

7. The method of claim 1, wherein in the active state the group of plural execution lanes perform processing operations in a single instruction, multiple data execution state.

8. The method of claim 1, further comprising: in response to the execution lanes in the active state executing a further, deactivation instruction in the program: causing all of the execution lanes in the group of plural execution lanes to return to their prior processing state.

9. A method of operating a graphics processor, the graphics processor comprising a programmable execution unit operable to execute programs to perform graphics processing operations, wherein the execution unit is configured as a plurality of execution lanes, wherein individual execution threads in a group of plural execution threads can be executed by respective execution lanes,
the method comprising:
when a group of executing threads being executed by a group of plural execution lanes are executing a program in which the group of plural execution lanes are in an active state in which one or more processing operations are being performed using the group of plural execution lanes together:
in response to the execution threads in the active state executing a deactivation instruction:
causing the execution threads to exit the active state in which the processing operations can be performed using the plural execution lanes together.

10. A method of compiling a shader program to be executed by a programmable execution unit of a graphics processor comprising a programmable execution unit operable to execute programs to perform graphics processing operations, wherein the execution unit is configured as a plurality of execution lanes, wherein individual execution threads in a group of plural execution threads can be executed by respective execution lanes;
the method comprising:
including in a program to be executed by a group of plural execution threads, an activation instruction that when executed by an execution thread in the group of execution threads will cause a group of plural execution lanes to be in an active state in which processing operations can be performed using the plural execution lanes together; and
including in the program, subsequent to the activation instruction that will cause the group of plural execution lanes to be in the active state, a set of one or more instructions to cause one or more processing operations to be performed using the group of plural execution lanes together.

11. A graphics processor comprising a programmable execution unit operable to execute programs to perform graphics processing operations, wherein the execution unit is configured as a plurality of execution lanes, wherein individual execution threads in a group of plural execution threads can be executed by respective execution lanes,
wherein the execution unit is configured such that:
when a program to perform a set of one or more processing operations is being executed by an execution thread, in response to the execution thread executing an activation instruction:
a group of plural execution lanes is caused to be in an active state such that the execution unit can then perform the set of one or more processing operations using the group of plural execution lanes together.

12. The graphics processor of claim 11, wherein the graphics processor is configured such that: after the one or more processing operations that are performed using the group of plural execution lanes together have finished, the execution unit allows the execution lanes to return to their previous execution state.

13. The graphics processor of claim 11, wherein the graphics processor is configured such that: in response to executing the activation instruction: for each execution lane in the group of plural execution lanes that is caused to be in the active state: the execution unit determines the execution state of the execution lane at the point prior to which the activation instruction was executed; and stores an indication of the prior execution state such that the execution lanes can be returned to their prior execution once the set of one or more processing operations using the group of plural execution lanes together has finished.

14. The graphics processor of claim 11, wherein the graphics processor is configured such that: in response to executing the activation instruction: for any execution lanes that are not active at the point at which the activation instruction is executed: the graphics processor is configured to generate a new execution thread for executing the set of one or more processing operations and to issue the generated thread to the execution unit accordingly.

15. The graphics processor of claim 11, wherein in response to executing the activation instruction: the graphics processor is configured to: for any execution lanes executing an execution thread that has diverged from the program that requires the one or more processing operations to be performed: store an indication of the current position of the part of the program being executed by the divergent thread such that the program execution can be continued once the one or more processing operations have been performed; and then cause the divergent execution thread to jump to the part of the program that requires the one or more processing operations to be performed.

16. The graphics processor of claim 11, wherein in response to executing the activation instruction: the graphics processor is configured to: cause all of the execution lanes in the group of execution lanes that are caused to be in the active state to jump to a sub-routine including the set of one or more instructions to perform the one or more processing operations that are to be performed using the group of plural execution lanes together, wherein an indication of a position of the sub-routine is included in the activation instruction.

17. The graphics processor of claim 11, wherein in the active state the group of plural execution lanes perform processing operations in a single instruction, multiple data execution state.

18. The graphics processor of claim 11, wherein when a program to perform a set of one or more processing operations is being executed by an execution thread, in response to the execution thread executing a deactivation instruction, that is included in the program subsequent to the activation instruction, the graphics processor is configured to cause all of the execution lanes in the active state to return to the processing state they were in prior to the activation instruction being executed.
